(19) United States
(12) Patent Application Publication
(10) Pub. No.: US 2002/0092908 A1
(43) Pub. Date: Jul. 18, 2002

(54) Apparatus for recording optically readable data on an optical mark-sense card

(76) Inventor: Gregory R. Chumbley, Fort Lauderdale, FL (US)

Correspondence Address: Robert M. Downey, P.A., Suite 350, 150 East Palmetto Park Road, Boca Raton, FL, 33432, US

(21) Appl. No.: 09/761,137

(22) Filed: Jan. 16, 2001

(51) Int. Cl. G06F 17/60

(52) U.S. Cl. 235/386

(57) ABSTRACT

An apparatus is designed for use with optical mark-sense cards which have predetermined bubble positions arranged on at least one side thereof. The apparatus includes a frame member with a flat backing surface, a template positionable in overlying relation to the backing surface and a guide for directing the optical mark-sense card in sliding receipt between the template and the backing surface so that holes formed through the template register in alignment with the bubble positions on the card. A stylus includes a normally concealed marker tip and a casing with a distal end structured for receipt and engagement within any of the template holes. The marker tip is selectively extendible from the distal end of the casing so that when the stylus is held in engagement within one of the desired holes, the marker tip can be extended to contact the card and place an optically readable mark at the bubble position aligned with the hole.

### BACKGROUND OF THE INVENTION

1. Field of the Invention

The invention relates generally to data recording devices and, more particularly, to a voting apparatus and system which facilitates placement of optical marks at predetermined locations on an optical mark-sense ballot card for subsequent reading by an optical mark reader/sensor when tabulating votes in an election.

2. Discussion of the Related Art

Numerous types of data collection and recording devices have been proposed in the art for collecting information from the public. In particular, various data collection and recording devices are well known for use in collecting and tabulating votes in a political election. Presently available voting machines range from sophisticated electronic devices to the more commonly found mechanical vote casting devices. While electronic voting machines are unquestionably more accurate and reliable, they are considerably expensive, often ranging between $3,000-$7,000 per unit. Due to budgetary restraints, many municipalities have no other choice but to use less expensive technology, such as punch card data recording.

Presently, a large percentage of voting precincts throughout the U.S. use punch card voting machines. These devices use punch cards that have index-point areas individually scored to provide selectively removable “chips” or punch outs commonly referred to as “chads.” The instrument employed to remove the chad, known as a stylus, is adapted to apply a sufficient force to break frangible connections between the chad and the card, thereby detaching the chad from the card. One particular punch card voting machine of this nature, known by the trademark VOTOMATIC, is widely used throughout voting precincts in the U.S. and abroad. Examples of this device are shown and described in detail in the Harris U.S. Pat. Nos. 3,201,038 and 3,240,409 and the Ahmann U.S. Pat. No. 4,297,566.

Punch card voting machines, such as those referred to above, have inherent flaws which can materially effect vote tabulations and the outcome of an election. Most problems associated with punch cards result from incomplete removal of the chad from the card. Typically, a template is used to guide the voter's punch or stylus onto a selected position on the ballot card. If, however, the voter does not hold the stylus straight up and down when punching, it is highly possible that the chad at the selected punch position will not be fully removed from the ballot card. It has also been discovered that the first row of punch positions along the left side of the ballot card is sometimes not adequately supported from below the card and, therefore, the stylus fails to punch out and completely remove the chad at the selected punch position. These and other factors can produce various degrees of incomplete chad removal, commonly referred to “hanging chad,” “swinging chad,” “pregnant chad,” or “dimpled chad.” A dimpled chad often results when the voter fails to push the stylus completely down in the selected punch position or if the punch card is not adequately supported at the area attempted to be punched, such as along the first column in some instances. Another problem which commonly results when using punch card voting machines is the casting of more than one vote in a particular contest or issue, commonly referred to as an “over vote.” This can result if the voter inserts the stylus into the wrong punch guide hole on the machine and then, after realizing the mistake, the voter punches the stylus a second time at the correct punch position. In some instances, the voter does not realize that the stylus actually punched out two separate chads along the same column (i.e., the same political contest or issue on the ballot). The problem of incomplete chad removal becomes particularly apparent during the tabulation process wherein thousands of punch card ballots are processed through a punch card tabulator which identifies the punched out openings on the ballot cards where the chad has been removed. The tabulator reads the punched out areas as votes cast by each voter. A problem arises in the vote tabulation process when punch card ballots, having one or more chads which is not completely removed, are fed through the tabulator. In most cases, a dimpled chad is not identified as a vote by the tabulator. Even swinging chad and hanging chad often blocks the punched out opening in the ballot card, resulting in the tabulator failing to identify the punched, but not completely removed, chad as a vote. While troublesome for many years, these and other problems were fully exposed to the public during the recent presidential election in November, 2000. In this extremely close presidential election, punch card ballots, particularly those cast in the state of Florida, came into real controversy and were highly scrutinized for weeks during painstaking recounts in several counties. The obvious flaws of the punch card voting system became quite apparent and have been identified as the primary culprit in the hotly contested, highly controversial presidential election.

Another popularly used technology for casting and tabulating votes involves placing readable marks within bubbles on an optical mark-sense card which is subsequently placed within an electronic device for optically reading the marks on the card. Presently, use of optical mark-sense technology requires a voter to use a conventional pencil or pen to fill in select bubbles directly on the ballot in order to cast votes. A problem arises when voters place stray marks on the ballot, outside of the select bubbles. When tabulating the votes, using optical mark-sensors to read the ballot cards, stray marks on the ballot often produce an error, causing the ballot scanning device to reject the ballot. In other instances, the scanning device may treat stray marks as an over vote, thereby discounting the voter's choice.

In view of the high cost of more reliable electronic voting machines, and the significant problems inherent with the use of punch card voting machines and presently used optical mark-sense ballot cards, there remains an urgent need for a relatively inexpensive, yet highly reliable voting system which significantly reduces the likelihood of voter error and which quickly and accurately tabulates votes cast in an election.

### OBJECTS AND ADVANTAGES OF THE INVENTION

With the foregoing in mind, it is a primary object of the present invention to provide a relatively low-cost, highly reliable system for recording optically readable data on an optical mark-sense ballot card.

It is also a primary object of the present invention to provide a highly reliable voting system for recording optically readable data on an optical mark-sense ballot card which replaces the less reliable and problematic punch card voting machines, as described above.

It is also a primary object of the present invention to provide a highly reliable voting system for recording and subsequently reading optically readable data on an optical mark-sense ballot card which uses an optical mark reader to thereby replace tabulators which are presently used for reading punch card ballots.

It is yet a further object of the present invention to provide a relatively inexpensive voting system which is particularly adapted to permit accurate recording of optically readable data on an optical mark-sense ballot card with no stray marks or error.

It is still a further object of the present invention to provide a voting system which utilizes a specially designed magic-marker type stylus that places a black indelible ink mark on a single-sided, optical mark-sense ballot having a plurality of numbered bubble positions.

It is still a further object of the present invention to provide a device which facilitates placement of optically readable marks at predetermined, numbered bubble positions on an optical mark-sense ballot card for subsequent reading by an optical mark reader/sensor positioned inside an electronic ballot box.

It is still a further object of the present invention to provide a voting device which includes a ballot card frame member, a template, a guide for directing an optical mark-sense ballot card between the template and the backing surface of the frame member so that holes form through the template register in alignment with numbered bubble positions on the ballot card, and wherein a magic marker type stylus is adapted to be placed within any select ones of the holes of the template to place an indelible ink mark within the bubble position aligned with the selected hole.

It is still a further object of the present invention to provide a voting device, as described above, which is adapted for easy and convenient retrofit within the support base of an existing punch card voting machine, such as a VOTOMATIC voting machine.

It is still a further object of the present invention to provide a voting system which includes a device for accurate placement of optically readable marks within select, numbered bubble positions on an optical mark-sense ballot and an electronic ballot box which accepts a completed ballot from a voter and instantly reads the ballot, tabulates the votes cast by the voter, and stores the ballot inside, preferably within a removable cardboard ballot box, in order to facilitate storage of the ballot cards after the election.

It is still a further object of the present invention to provide a voting system, as described above, wherein the electronic ballot box is structured to reject any ballots containing errors, including over votes.

It is still a further object of the present invention to provide a voting system, as described above, wherein the electronic ballot box includes a built-in printer, enabling a poll worker to print precinct election results and an audit trail report immediately after the poll closes.

It is still a further object of the present invention to provide a voting system, as described above, wherein the electronic ballot box is adapted to transmit the precinct election results and audit trail report by modem to a central election office for final consolidation.

It is still a further object of the present invention to provide a voting system, as described above, which substantially reduces the need for anyone other than the voters to physically handle the ballots while voting and after the election.

It is yet a further object of the present invention to provide a voting system, as described above, which is particularly adapted for use with 12 column optical mark-sense cards.

These and other objects and advantages of the invention are more readily apparent with reference to the following detailed description.

### SUMMARY OF THE INVENTION

The present invention provides an apparatus and system which facilitates placement of optically readable marks at predetermined locations on an optical mark-sense ballot card for subsequent reading by an optical mark reader/sensor when tabulating votes in an election. In a preferred embodiment, the system incorporates the use of an electronic ballot box which is adapted for accepting the ballots directly from the voter. The ballot box contains the optical mark reader/sensor which immediately reads the inserted ballot and tabulates all votes cast at a particular poll. The placement of optical marks on the optical mark-sense ballot cards is facilitated by the use of a device which includes a ballot card frame member, a template positioned in overlying relation to a backing surface on the frame member, and a guide for directing the optical mark-sense card in sliding receipt between the template and the backing surface. Means are provided for holding the inserted ballot card in an operative position for voting, so that holes form through the template register in alignment with a predetermined arrangement of numbered bubble positions on the ballot card. A magic marker type stylus includes a normally concealed marker tip and a casing with a distal end which is structured for receipt and engagement within the template holes. To cast a vote, the distal end of the stylus is inserted into a desired template hole and the marker tip is extended from the distal end of the stylus casing, causing the marker tip to contact the ballot card and place an indelible ink mark at the numbered bubble position aligned with the desired hole, representing the voter's choice.

### BRIEF DESCRIPTION OF THE DRAWINGS

For a fuller understanding of the nature of the present invention, reference should be made to the following detailed description taken in conjunction with the accompanying drawings in which:

FIG. 1 is a top plan view of the frame member of the optical mark recording device of the present invention including a ballot card guide chute and backing surface for supporting an optical mark-sense ballot card in operative position when voting;

FIG. 2 is a side elevation, in cross-section, showing the frame member of FIG. 1 with an overlying template and a ballot card inserted in operative position between the template and the backing surface of the frame member;

FIG. 3 is a top plan view of the template, showing a plurality of holes formed therethrough, and positioned and arranged for corresponding alignment with numbered positions on the ballot card;

FIG. 4 is a top plan view of the optical mark-sense ballot card used in conjunction with the device of the present invention;

FIG. 5 is a side elevation, in partial section, showing a stylus of the present invention adapted for insertion within the holes of the template for placing optically readable marks at select numbered positions on the ballot card;

FIG. 6 is a side elevational view showing the stylus inserted within a selected hole of the template with a marker tip of the stylus extended and engaging the ballot card underlying the template for placing the mark at the predetermined numbered position aligned with the selected hole;

FIG. 7 is an isolated view of a distal end of the stylus showing the distal end inserted within the selected hole of the template with the marker tip engaging the ballot;

FIG. 8 is an isolated view of the marker card, including the marker tip, contained within the stylus casing;

FIG. 9 is a front, top perspective view of an electronic ballot box according to the voting system of the present invention;

FIG. 10 is a rear elevational view of the ballot box of FIG. 9; and

FIG. 11 is a schematic diagram illustrating the functional components of the electronic ballot box of FIG. 9.

Like reference numerals refer to like parts throughout the several views of the drawings.

### DETAILED DESCRIPTION OF THE PREFERRED EMBODIMENTS

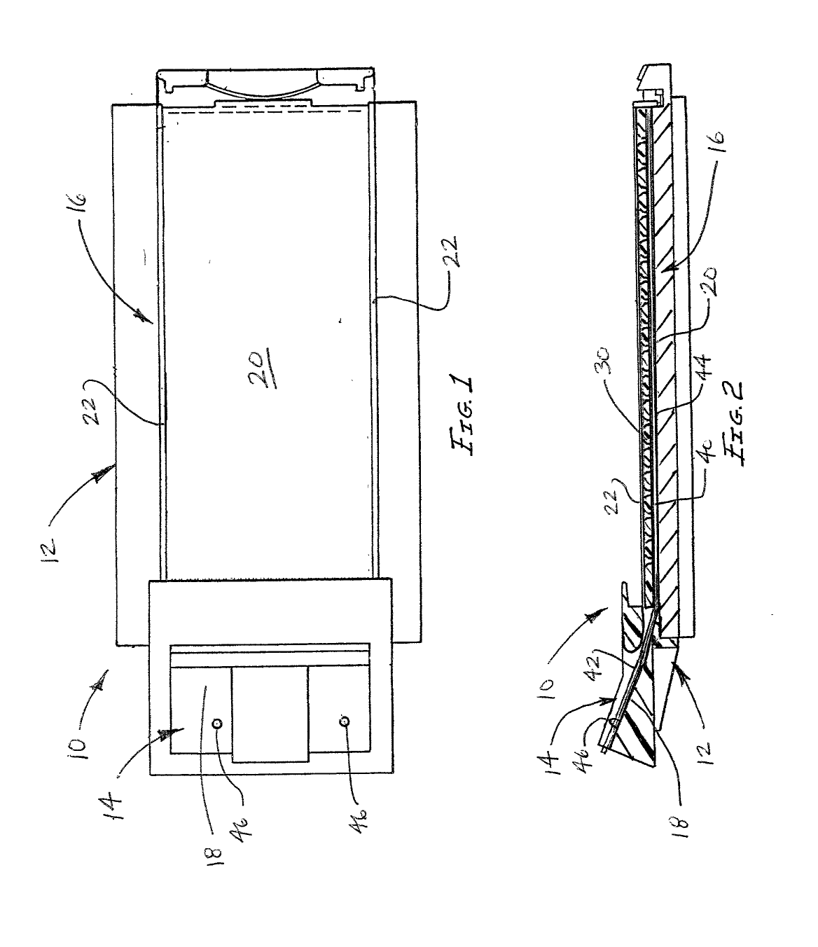

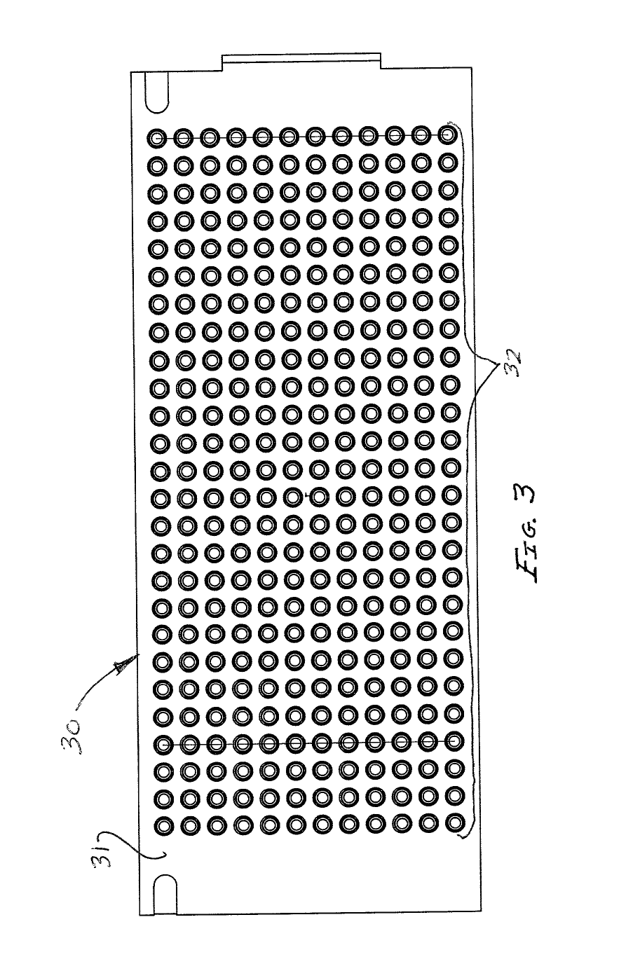

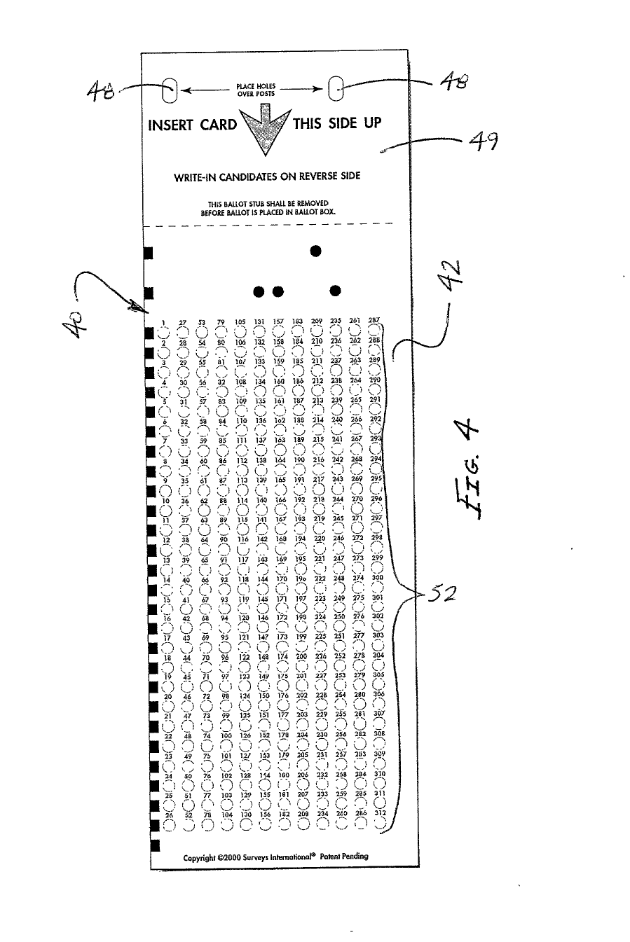

Referring initially to FIGS. 1 and 2, a device used to facilitate precise placement of optically readable marks on an optical mark-sense ballot card is shown in accordance with a preferred embodiment of the invention. The device, generally indicated as 10, includes a frame member 12 having a first end portion 14 and a second portion 16. The first portion 14 includes a card guiding chute 18 for sliding receipt of an optical mark-sense card, of the type shown in FIG. 4. The card guide chute 18 extends to and communicates with a card backing surface 20 on the second portion 16 of the frame member 12. Flanges 22 extend upwardly on opposite sides of the backing surface 20 run parallel to one another along a length of the second portion 16 of the frame member. A template 30, as seen in FIGS. 2 and 3, is removably positionable in overlying relation to the backing surface 20 and is held between the upwardly extending flanges 22. The card guide chute 18, backing surface 20 and template 30 are structured and arranged to permit sliding receipt of the optical mark-sense ballot card 40 through the chute and between the template 30 and backing surface 20, so that a top side 42 of the card 40 faces the template and the back side 44 of the card rests against the backing surface. A pair of upwardly extending pins 46 on the card guide chute provide means for holding the inserted card 40 in an operative position so that a plurality of holes 32 formed through the template 30 register in alignment with predetermined numbered bubble positions 52 on the top side of the card 40. Specifically, the holes 32 formed through the template are positioned and arranged for corresponding alignment with the numbered bubble positions 52 on the card. In a preferred embodiment, a 12 column optical mark-sense card is used, as seen in FIG. 4, wherein there are a total of 312 individually numbered bubble positions arranged in 26 horizontal rows and 12 vertical columns. The holes in the template are identically arranged, as seen in FIG. 3, so that each hole in the template registers in alignment with one of the 312 numbered bubble positions on the card. Elongate holes 48 in the top portion 49 of the card 40 are adapted for receipt of the pins therethrough to hold the card in the operative position, while also indicating to the user that the card is properly positioned within the device 10.

As seen in FIGS. 3 and 7, each of the holes in the template are specifically formed and configured to include an upper portion 34 and a lower portion 36. The upper portion includes a larger diameter at the top surface 31 of the template 30 which tapers (i.e., reduces in diameter) towards the lower portion 36 of the hole. The lower portion 36 of each hole 32 is provided with a uniform diameter which is smaller than the diameter of the opening of the upper portion 34, at the top surface of the template. Moreover, the lower portion 36 of the hole 32 is concentrically positioned relative to the upper portion 34. The tapered, funnel-like configuration of the upper portion of each of the holes defines a seat for mating engagement with a distal end of a stylus, as described more fully hereinafter.

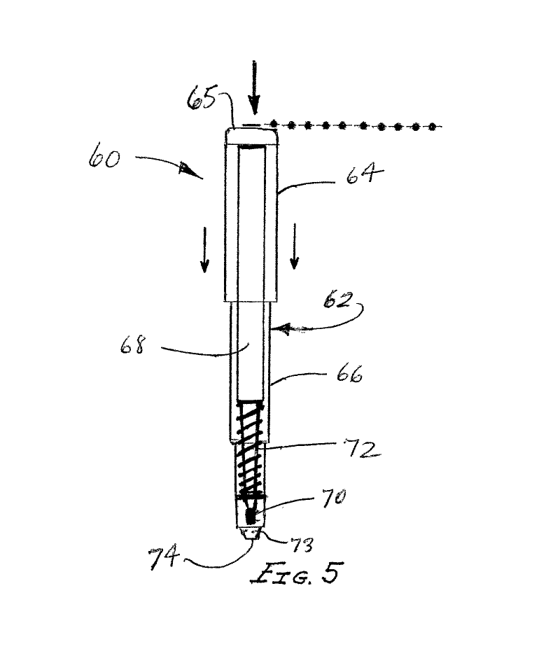

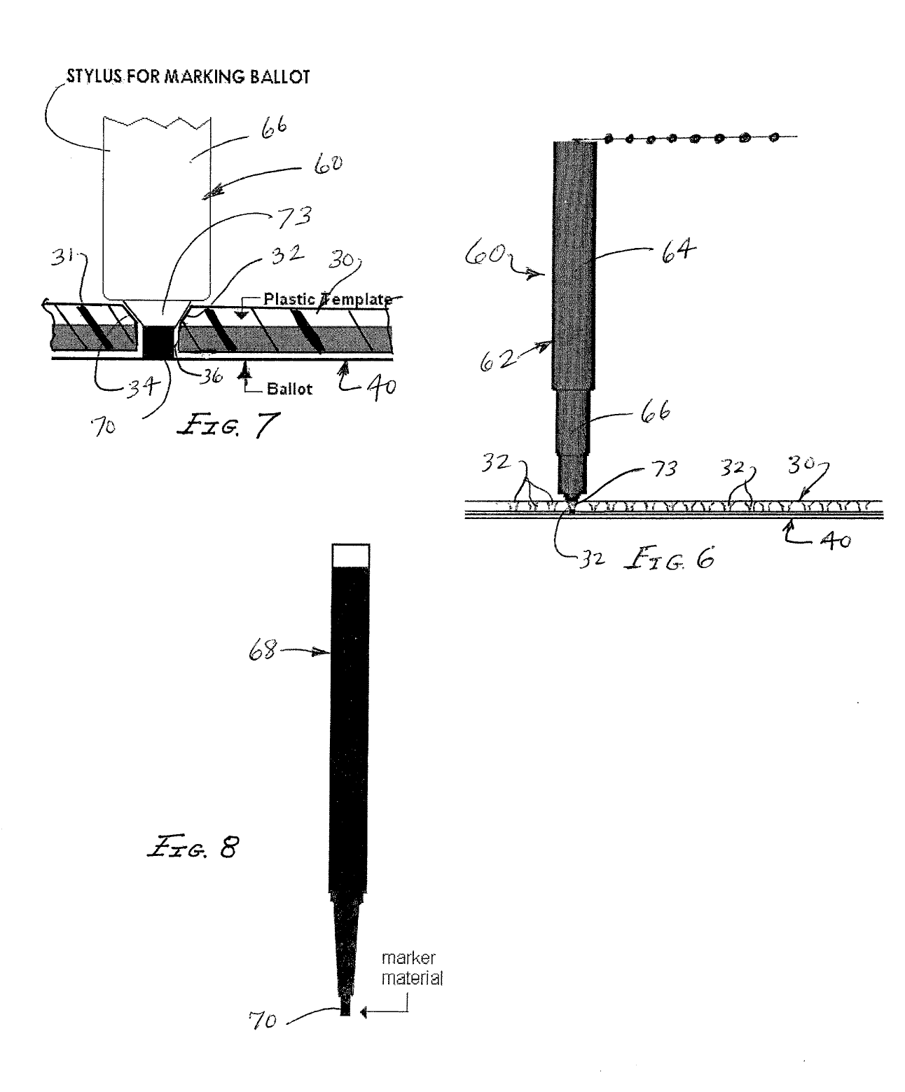

With the card 40 inserted within the device 10 and held in the operative position, as described above, a magic marker type stylus 60, as shown in FIGS. 5-8, is used for placing a black indelible ink mark within the selected bubble positions 52 on the ballot card. More specifically, the stylus 60 includes an outer casing 62 including a top portion 64 and a bottom portion 66. The top and bottom portions of the stylus casing are movably coupled together to encapsulate a cartridge member 68. The cartridge member 68 includes a marker tip 70 which is specifically structured and configured for passage through the upper and lower portions 34, 36 of the holes 32 in the template 30 for placing the indelible ink mark within any of the selected numbered bubble positions 52 on the card 40. As seen in FIG. 5, the cartridge is normally maintained in a relaxed position, with a spring 72 urging the cartridge 68 and marker tip 70 upwardly relative to the surrounding casing 62 so that the marker tip 70 remains concealed within the stylus casing. In this relaxed position, the marker tip does not protrude from the open distal end 74 at the distal end zone 73 of the stylus casing, thereby allowing the distal end zone 73 of the stylus to be inserted and positioned within a selected hole 32 of the template 30 without damaging the marker tip 70 or depositing ink on the template. Once the voter has selected a desired hole for insertion of the stylus, corresponding with a numbered position on the ballot card and a candidate or referendum on a ballot fitted in overlying relation to the template, the voter inserts the distal end zone 73 of the stylus 60 into position within the selected hole 32. When the stylus 60 is properly positioned, the distal end zone 73 seats against the upper portion 34 of the selected hole. It should be noted that the distal end zone 73 of the stylus is specifically structured and configured for receipt and mating, seated engagement with the upper portion 34 of the holes 32. With the stylus properly positioned in the hole, the voter depresses downwardly on the top end 65 of the stylus, as indicated by the arrow in FIG. 5, thereby causing the top portion 64 of the stylus casing to move relative to the bottom portion 66, and urging the cartridge 68 downwardly against the spring, to thereby extend the marker tip outwardly from the distal end of the casing. This results in the marker tip 70 of the stylus moving through the lower portion 36 of the template hole 32 and into engagement with the aligned numbered bubble position on the card. Upon contacting the card, at the aligned bubble position, the marker tip 70 places an indelible ink mark which fills in a suitable portion of the numbered bubble position. The voter then releases pressure on the top of the stylus, causing the spring 72 to urge the cartridge 68 back to the relaxed position as the marker tip 70 retracts into protective, concealed relation within the stylus casing. The stylus 60 can then be removed from the hole 32 and the voter can then move onto the next political contest or issue on the ballot, for casting subsequent votes in the same manner.

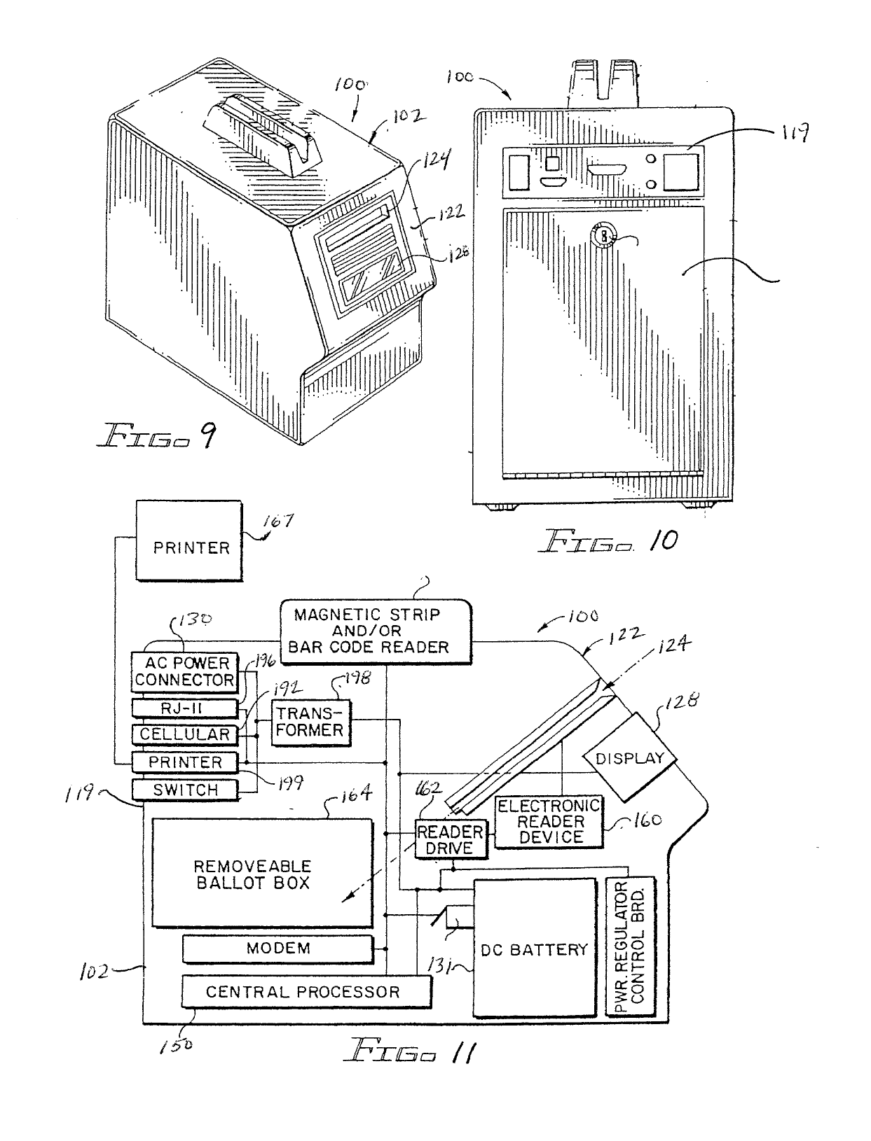

When the voter has completed voting, the optical mark-sense ballot card 40 is removed from the device by lifting the top portion 49 of the card away from the pins 46 and pulling the card outwardly relative to the card guide chute 18. The voter can then deposit the completed ballot card into an electronic ballot box 100, as seen in FIGS. 9-11. Specifically, the voter simply inserts the completed ballot card 40 into a slot opening 124 on the front 122 of the electronic ballot box 100. Once inserted into the slot, the ballot card is pulled inside, and the voter's marks on the ballot card are read by electronic reader device 160. The marks on each ballot are tabulated and the ballot is dropped into a removable cardboard box 164 stored inside of the electronic ballot box 100 housing 102.

In a preferred embodiment, the electronic ballot box 100 includes a display 128 on the front side 122. The visual character display 128 interconnects with a central processor 150 and receives messages from the central processor's memory for display. The particular message is transmitted from the central processor 150 to the display 128 are prompted by various actions and operations of the various components during use. The electronic reader device 160 supported within the housing of the electronic ballot box 100 includes a reader drive 162 specifically structured to pull the ballot card 40 through the slot opening 124 and past the reader device 160 for scanning thereof. The reader device 160 is structured to scan and read the marked ballot card 40 once pulled therethrough in order to detect and locate the marks made by the voter. After scanning the card, the reader drive 62 directs the ballot card 40 into the cardboard ballot card collection box 164.

Referring to FIG. 11, there is schematically illustrated the electronic ballot box 100, in accordance with a preferred embodiment thereof, including various component elements which are powered by an internal battery 131. A power cord connects to an AC power connector port 130 for recharging the internal battery 131. The central processor 150 includes a control circuit for controlling operation of the various components of the device and a memory means for storing data therein. The memory means is preprogrammed with an initialization file and a database of all registered voters who are registered in the district or precinct where the device is to be used during an election. The back panel 119 is provided with several ports and/or jacks to facilitate interconnection of the device with various external components such as an external printer. An RJ-11 port 196 facilitates transfer of data via an internal modem. The electronic ballot box 100 can be interconnected to an external printer device 167, via the printer port 199. Alternatively, an internal printer may be provided within the device and interconnected with the central processor. In either case, a poll worker is able to print precinct election results and an audit trail report directly from the electronic ballot box after the poll closes. Both the precinct election results and audit trail report can then be transmitted by modem to a central election office for final consolidation.

A hinge door 210 on the rear panel includes a lock 212 to secure the housing interior. After the closing of the poll, the door can be unlocked and opened by the poll worker in order to remove the ballot card collection box containing all of the ballot cards.

While the instant invention has been shown and described in what is considered to be preferred and practical embodiments thereof, it is recognized that departures from the instant disclosure are contemplated within the spirit and scope of the invention as set forth in the following claims and within the doctrine of equivalents.

What is claimed is:

1. A data registering device for use with an optical mark-sense ballot card having a plurality of identified areas arranged on a top side of the ballot card according to predetermined positions, said device comprising:
a frame member including a flat backing surface;
a template positionable on said frame member in overlying relation to said backing surface and including a plurality of holes formed therethrough, said holes being positioned and arranged to correspond with the predetermined positions of the identified areas on the ballot card;
means for guiding the ballot card between said template and said backing surface with the top side of the card facing said template;
means for removably holding the ballot card in a precise, predetermined position between said template and said backing surface so that said plurality of identified areas on the ballot card align with said plurality of holes in said template; and
marking means for placing optically readable marks on the ballot card and including a marker tip structured and disposed for receipt through said holes of said template to place the optically readable marks within the identified areas aligned with the holes through which the marker tip is selectively received.

2. The device as recited in claim 1 wherein said marker means includes a stylus including:
a housing having a proximal end portion and a distal end portion with an open distal end;
said marker tip carried within said housing and movable between a normally relaxed position defined by said marker tip being concealed within said housing, and an extended position defined by said marker tip extending outwardly from said open distal end;
means for urging said marker tip outwardly from said distal end of said marker housing to said extended position; and
said marker tip being structured and disposed for receipt and passage through said holes of said templates to place the optically readable mark on the ballot card within the identified area aligned with the hole within which the stylus is positioned as said marker tip is moved to the extended position.

3. The device as recited in claim 2 wherein said plurality of holes formed through said template each include an upper portion and a lower portion, said upper portion having a larger diameter than said lower portion.

4. The device as recited in claim 3 wherein said upper portion of each of said plurality of holes includes seat means for seated engagement with said distal end portion of said stylus.

5. The device as recited in claim 4 wherein said distal end portion of said stylus is structured and disposed for receipt within said upper portion of said holes of said template for seated engagement with said seat means.

6. The device as recited in claim 5 wherein said stylus includes biasing means for urging said marker tip towards said normally relaxed position.

7. A data registering device for use with an optical mark-sense ballot card having a plurality of identified areas arranged on a top side of the ballot card according to predetermined positions, said device comprising:
a frame member including a flat backing surface;
a template positionable on said frame member in overlying relation to said backing surface and including a plurality of holes formed therethrough, said holes being positioned and arranged to correspond with the predetermined positions of the identified areas on the ballot card;
means for guiding the ballot card between said template and said backing surface with the top side of the card facing said template;
means for removably holding the ballot card in a precise, predetermined position between said template and said backing surface so that said plurality of identified areas on the ballot card align with said plurality of holes in said template;
a stylus including:
a housing having a proximal end portion and a distal end portion with an open distal end;
a marker tip carried within said housing and movable between a normally relaxed position defined by said marker tip being concealed within said housing, and an extended position defined by said marker tip extending outwardly from said open distal end;
means for urging said marker tip outwardly from said distal end of said marker housing to said extended position; and
said marker tip being structured and disposed for receipt and passage through said holes of said template to place an optically readable mark on the ballot card within the identified area aligned with the hole within which the stylus is positioned as said marker tip is moved to the extended position.

8. The device as recited in claim 7 wherein said plurality of holes formed through said template each include an upper portion and a lower portion, said upper portion having a larger diameter than said lower portion.

9. The device as recited in claim 8 wherein said upper portion of each of said plurality of holes includes seat means for seated engagement with said distal end portion of said stylus.

10. The device as recited in claim 9 wherein said distal end portion of said stylus is structured and disposed for receipt within said upper portion of said holes of said template and for seated engagement with said seat means.

11. The device as recited in claim 10 wherein said stylus includes biasing means for urging said marker tip towards said normally relaxed position.

12. The device as recited in claim 11 wherein said housing of said stylus includes a top portion and a bottom portion, said top portion being movably coupled to said bottom portion and said top portion being movable relative to said bottom portion in response to an externally applied downward force to move said marker tip to said extended position, and said biasing means being structured for moving said top portion of said stylus housing back to a normally relaxed position upon removal of said externally applied downward force.

13. The device as recited in claim 12 wherein said means for removably holding the ballot card include a pair of post members on said frame member, said post members being positioned and disposed for receipt through openings in said ballot card when said ballot card is in said precise, predetermined position.

14. A voting system for use with an optical mark-sense ballot card having a plurality of identified areas arranged on a top side of the ballot card according to predetermined positions, said system comprising:
a device to facilitate placement of optically readable marks on the ballot card, said device comprising
a frame member including a flat backing surface;
a template positionable on said frame member in overlying relation to said backing surface and including a plurality of holes formed therethrough, said holes being positioned and arranged to correspond with the predetermined positions of the identified areas on the ballot card;
means for guiding the ballot card between said template and said backing surface with the top side of the card facing said template;
means for removably holding the ballot card in a precise, predetermined position between said template and said backing surface so that said plurality of identified areas on the ballot card align with said plurality of holes in said template; and
marking means for placing the optically readable marks on the ballot card and including a marker tip structured and disposed for receipt through said holes of said template to place the optically readable marks within the identified areas aligned with the holes through which the marker tip is selectively received;
a device for collecting the ballot cards after completion of placement of the optically readable marks thereon by voters, said device comprising:
a housing including a slot opening sized and configured for receipt of the ballot cards therethrough;
an electronic reader positioned and disposed in communication with said slot opening and structured to scan and read said ballot cards to identify voting data thereon, including the optically readable marks;
a central processor unit including memory means for storing data, including the voting data, and said memory means being further structured for tallying votes represented by the optically readable marks placed on the ballot cards by the voters; and
printer means for printing reports and election results based on the collected voting data.

15. The system as recited in claim 14 wherein said marker means includes a stylus including:
a housing having a proximal end portion and a distal end portion with an open distal end;
said marker tip carried within said housing and movable between a normally relaxed position defined by said marker tip being concealed within said housing, and an extended position defined by said marker tip extending outwardly from said open distal end;
means for urging said marker tip outwardly from said distal end of said marker housing to said extended position; and
said marker tip being structured and disposed for receipt and passage through said holes of said templates to place the optically readable mark on the ballot card within the identified area aligned with the hole within which the stylus is positioned as said marker tip is moved to the extended position.

16. The system as recited in claim 15 wherein said plurality of said holes formed through said template each include an upper portion and a lower portion, said upper portion having a larger diameter than said lower portion.

17. The system as recited in claim 16 wherein said upper portion of each of said plurality of holes includes seat means for seated engagement with said distal end portion of said stylus.

18. The system as recited in claim 17 wherein said distal end portion of said stylus is structured and disposed for receipt within said upper portion of said holes of said template and for seated engagement with said seat means.

19. The system as recited in claim 18 wherein said stylus includes biasing means for urging said marker tip towards said normally relaxed position.

20. The system as recited in claim 14 wherein said device for collecting the ballot cards further comprises:
visual display means for displaying information including instructional information relating to use and operation of said device.
